(19) United States
(12) Patent Application Publication
(10) Pub. No.: US 2022/0126535 A1
(43) Pub. Date: Apr. 28, 2022

(54) TOOL FOR PREFORMING A FIBROUS PREFORM AND METHOD FOR PREFORMING A FIBROUS PREFORM

(71) Applicant: SAFRAN AIRCRAFT ENGINES, Paris (FR)

(72) Inventor: Steven Gerard Joseph BIENVENU, Moissy-Cramayel (FR)

(21) Appl. No.: 17/434,307

(22) PCT Filed: Mar. 18, 2020
(86) PCT No.: PCT/FR2020/050590

§ 371 Date: Aug. 26, 2021

(30) Foreign Application Priority Data
Mar. 27, 2019 (FR) 1903191

(51) Int. Cl. B29C 70/54; B29C 70/34; B29B 11/16

(52) U.S. Cl. CPC B29C 70/544; B29B 11/16; B29C 70/342

(57) ABSTRACT

A tool for preforming a fibrous preform, including an inflatable first membrane intended to accept the fibrous preform, a second membrane intended to attach to the first membrane via a fixing system in such a way as to form a fluidtight internal cavity between the first and second membranes, and an evacuation device for creating a vacuum in the internal cavity between the first membrane and the second membrane.

### TECHNICAL FIELD OF THE INVENTION

The present invention relates to the field of the turbomachine parts made of composite material for aircraft. In particular, it covers the design and/or manufacture of these composite parts as well as the corresponding tool.

### BACKGROUND

The turbomachines are increasingly equipped with complex shaped parts and at least partly made of composite materials. These composite materials comprise a fibrous reinforcement embedded in a matrix so as, on the one hand, to reduce the masses and improve the thermomechanical resistances of these parts, and on the other hand, to improve the performance of the turbomachine. Examples of the composite materials are described in the documents US-A1-2014/175709, U.S. Pat. No. 8,419,875 B2 and US-A1-2013/099427.

In general, the fibrous reinforcement, which is composed of dry fibers, is deposited in a rigid mold and then a matrix is injected at low pressure into the previously closed mold. The best known method is the RTM technology, which stands for Resin Transfer Molding, which allows to produce parts of a very high quality and a good repeatability. However, this method is not suitable for the very complex shapes that may be presented by, for example, a variable discharge valve conduit that is intended to discharge a portion of the air from the primary flow circulating through the compressor to the secondary flow in order to regulate the flow rate of the compressor.

The variable discharge valve conduit is a single part of composite material and comprises outgoing pipes, elbows, fittings, etc. The difficulty with this type of part is the placement of the fibrous folds or fibrous structures that make up the fibrous reinforcement. The fibrous folds have a certain rigidity due to the weaving of the strands or threads (a strand is composed of several thousand filaments). In general, the fibrous reinforcement that forms the fibrous preform of the discharge valve conduit is previously shaped on an external support and is stiffened to facilitate the placement in the injection mold and the subsequent injection of the matrix into the injection mold. In this example, the fibrous reinforcement is shaped in the rigid injection mold.

For this purpose, a tackifier or deionized water is applied to the different folds in order to temporarily bind the different folds together and to hold the folds in the mold, and to allow the injection of the matrix. The water allows a breakage in the electrical attraction between the negatively charged chains, as well as a breakage in the hydrogen bonds and the peptide bonds when the folds are wet. These bonds are activated during the drying process. As for the tackifier, it is a kind of weak bonding adhesive.

The use of either of these products results in a fairly long drying time, which impacts the manufacturing time of the final part, and a fairly low mechanical strength to hold the folds together, which implies decohesion and losses of some parts of folds. The draping time by a manual operator and the size of the parts do not allow the fibres to be held correctly as a whole. Also, if the fibres move during the injection of the matrix or are badly arranged, the final part will not have the expected mechanical properties. For the tackifier in particular, during the injection of the matrix, the latter binds to the tackifier, whereas the tackifier is supposed to be pushed by the matrix when it is injected, which reduces the mechanical properties of this matrix. Once the part has been made, the tackifier, if not pushed by the resin in particular, causes defects in the part such as porosity or delamination.

In addition to this problem of placing the fibrous reinforcement in the mold, there is also the problem of the demolding of the preform from its shaping support, in particular for the discharge valve conduit having a complex shape and does not have any draft angles. The preform, previously shaped and stiffened, is impossible to demold if the support is rigid and in one part. The manufacturing time of the preform as well as the difficulties of demolding lead to a considerable loss of time as well as a certain number of rejects due to the decohesion of the dry fibres from certain parts of fibres.

The present invention aims in particular at simplifying and facilitating the shaping of a fibrous preform for a composite material part of complex shape so as to optimize the injection of matrix for its densification.

### SUMMARY OF THE INVENTION

This is achieved in accordance with the invention by means of a tool for preforming a fibrous preform comprising:
an inflatable first membrane intended to receive the fibrous preform with a fibrous reinforcement,
a second membrane intended to attach to the first membrane via an attachment system and so as to form a fluid-tight internal cavity between the first and the second membranes, and
a device for evacuating the internal cavity between the first membrane and the second membrane.

Thus, this solution allows to achieve the above-mentioned objective. In particular, the tool allows to facilitate the placing of the folds intended to form the fibrous preform on the first (referred to as male) membrane, to compact the preform between the first membrane and the second (referred to as female) membrane with the aid of the vacuum, to facilitate the demolding of the preformed preform by removing the second female membrane once the vacuum has been cut and by extracting the first male membrane once the latter has been deflated. In particular, the tool allows to save time since the tool also allows the drying of the folds forming the fibrous preform and its demolding without risk of decohesion and deformation of the preformed fibrous preform before the injection of the matrix.

In the present invention, the term “preforming” is used to mean the shaping and the holding of the shape of the preform before a matrix impregnates the fibers thereof. The preformed preform then has or approaches the shape that the final part should have.

The tool also comprises one or more of the following characteristics, taken alone or in combination:
the first membrane comprises a wall which is closed so as to form a chamber.
at least the first membrane is made of an elastic material.
the elastic material comprises a silicone.
the first membrane and the second membrane are releasably attached to each other.
the attachment system comprises sealing elements.
the evacuation device comprises a vacuum pump or a venturi effect system or a compressor.

The invention also relates to a method for preforming a fibrous preform comprising the following steps:
providing a preforming tool comprising an inflatable first membrane and a second membrane attached to the first membrane so as to form a fluid-tight internal cavity between the first and the second membranes;
inflating the first membrane;
placing fibrous folds intended to form a fibrous preform on the first membrane;
applying the second membrane on the fibrous preform and on the first membrane;
evacuating the internal cavity between the first and the second membranes; and
demolding a preformed and dry fibrous preform.

The method for preforming the fibrous preform also comprises one or more of the following characteristics, taken alone or in combination:
the step of placing the folds comprises a humidification of each fold forming the humidified fibrous preform.
the fibers of the fibrous preform are not impregnated with a resin before the humidification.
the evacuation step comprises a drying and a compacting of the humidified fibrous preform.
the humidification is carried out with deionized and filtered water.
the evacuation step is carried out for a predetermined time.
the step for demolding the preformed preform comprises a removing of the second membrane and a deflating of the first membrane.

The invention further relates to a method for manufacturing a turbomachine part comprising the following steps:
producing a fibrous preform;
preforming the fibrous preform according to a method having any of the above-mentioned characteristics;
placing the preformed preform in an injection mold;
injecting a matrix into the preformed preform.

### BRIEF DESCRIPTION OF FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings in which:

FIG. 1 is a side view of an example of a variable discharge valve conduit of a turbomachine according to the invention;

FIG. 2 shows a top view of an example of a discharge valve conduit according to the invention; and,

FIG. 3 schematically illustrates an example of tool for preforming a fibrous preform according to the invention.

### DETAILED DESCRIPTION OF THE INVENTION

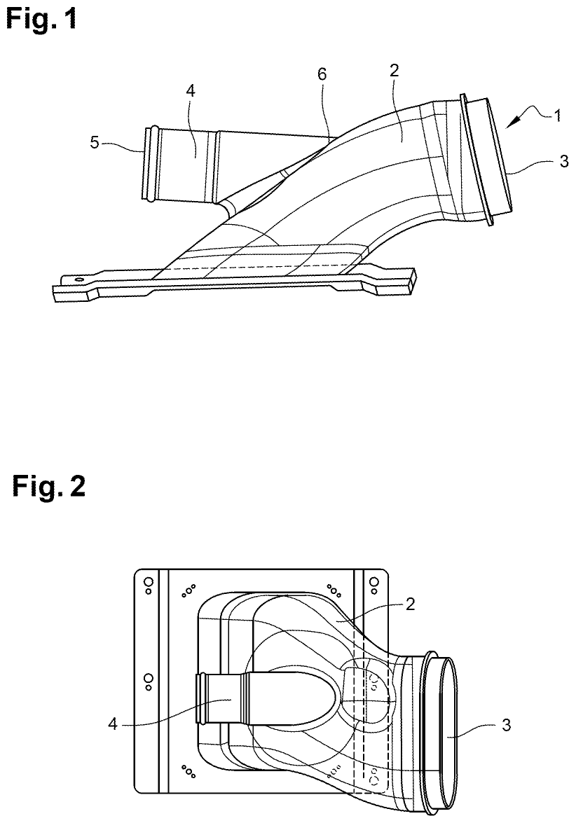

FIG. 1 shows an aircraft turbomachine part made of a single part of composite material.

FIGS. 1 and 2 illustrate precisely a variable discharge valve conduit 1 intended to equip the dual flow turbomachines. This variable discharge valve conduit 1 comprises a main pipe 2 allowing to connect a portion of a primary duct to a portion of a secondary duct of a dual flow turbomachines. The conduit 1 comprises a variable discharge valve installed (not shown) in the opening 3 of the main pipe 2 opening into the secondary duct. The conduit 1 also comprises a secondary pipe 4 having a first end 5 which opens into a pipe allowing to cool the hot parts of the low pressure turbine of the turbomachine and a second end 6 which opens into the main pipe 2. This conduit 1 is substantially S-shaped and has numerous curvilinear portions as shown in FIGS. 1 and 2. Of course, the invention can be applied to all parts of complex shape made of composite material and intended to equip a turbomachine.

The turbomachine part (here the conduit 1) made of composite material is made with a fibrous reinforcement (not shown) and a matrix in which the fibrous reinforcement is embedded. The fibrous reinforcement comprises a plurality of folds, laps, layers or structures of fibers bonded together. These folds can be three-dimensional (3D woven), two-dimensional (2D woven) of threads or strands that are each composed of several filaments or unidirectional. The fibrous reinforcement is intended to form the fibrous preform which has the general shape of the part to be obtained.

The threads or strands can be of various types. In the example embodiment, the material of the threads may comprise carbon, glass, polyamide, Kevlar, ceramic or a mixture of these materials.

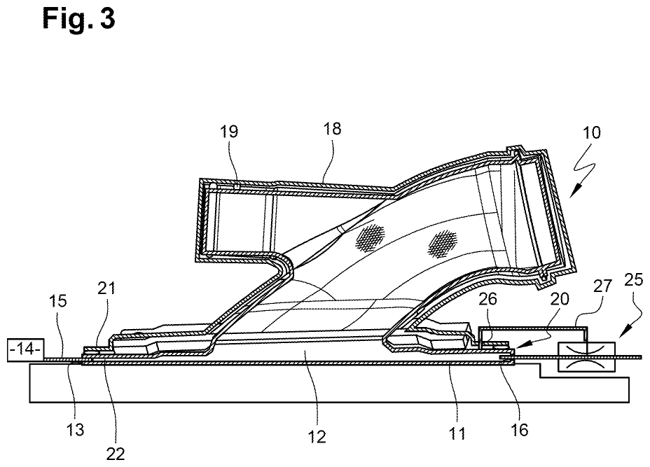

FIG. 3 schematically illustrates a preforming tool 10 intended to shape or even to freeze the shape of the fibrous preform so that it is as close as possible to the shape of the final part to be produced and, above all, to hold it during the impregnation with a specific matrix.

The preforming tool 10 comprises a first membrane 11 (referred to as male) which is intended to receive the fibrous preform. The first membrane 11 is inflatable (and deflatable) so as to facilitate the placing of the fibrous preform on the one hand, and to facilitate the subsequent demolding of the preform without risk of damaging it on the other hand. The first membrane 11 is made of an elastic material so that it can be inflated and deflated. By “inflatable” we mean that the volume of the membrane is increased by means of a fluid. As the fluid is evacuated, the membrane deflates back to its original volume.

Advantageously, but not limited, the elastic material comprises an elastomer such as a silicone. The silicone is shaped and cured to the predetermined dimensions to accommodate the fibrous preform. In particular, in the present example, the first membrane 11 comprises a wall which has a shape intended to give the corresponding shape to the fibrous preform to be applied thereto, when the first membrane is inflated. The wall can be of any shape.

The wall of the first membrane is closed so as to form a chamber 12 receiving air, preferably under pressure. The wall of the first membrane 11 comprises an inlet orifice 13 for supplying air to the chamber 12.

The tool 10 comprises an inflation system 14 (shown schematically) which is connected on the one hand to a source of compressed air and on the other hand to a nozzle 15 which is intended to be coupled to the inlet orifice 13 of the first membrane 11. The compressed air source provides the air necessary to inflate the first membrane 11.

The wall of the first membrane 11 also comprises an outlet orifice 16. The latter is provided with a movable wall portion so as to occupy a first position in which the outlet orifice is closed and a second position in which the outlet orifice is open. It goes without saying that in the first position, the chamber retains the air during its inflation (filling with air) or after inflation, and in the second position, the chamber empties its air through the outlet orifice 16 to deflate the first membrane 11.

The tool 10 also comprises a second (referred to as female) membrane 18 which is fluid-tightly attached to the first membrane 11. The second membrane 18 cooperates with the first membrane to form a fluid-tight internal cavity 19 between the first membrane and the second membrane. For this purpose, the tool 10 comprises an attachment system 20 which is installed at the level of the peripheral edges 21, 22 of the first and second membranes 11, 18.

However, the first and second membranes 11, 18 are releasably attached to each other via the attachment system 20 and to facilitate the removal of the preformed preform.

In the present example, the attachment system 20 is located at least in part on the first membrane 11 and/or on the second membrane 18. The attachment system may comprise a fluid-tight zip.

Advantageously, but not limited, the attachment system 20 comprises sealing elements comprising a seal of deformable material. The seal is fitted during the manufacturing method and the placing of the male and female membranes. This deformable material can be a Plastiline® strip. The sealing elements allow to hold a space between the membranes and thus facilitate the formation of the internal cavity.

Alternatively, the attachment system 20 comprises clip-on elements between the first and the second membranes. In this case, one of the first and second membranes comprises a groove for example and the other of the first and second membranes comprises a bracket shaped like an omega for example. The bracket and the groove fit together to form a seal.

The second membrane 18 is also made of an elastic material. As with the first membrane, the elastic material can be a silicone.

The tool 10 comprises a device 25 for evacuating the internal cavity between the first membrane and the second membrane. The evacuation device comprises a vacuum pump or a compressor which is connected to a suction orifice 26 formed here in the wall of the second membrane 18 by means of a pipe 27.

Alternatively, the evacuation device comprises a venturi effect system which provides a cross-sectional difference across the pipe connected to the suction orifice to create a pressure difference. The venturi effect system is easy to maintain and economical.

We will now describe the method for preforming the fibrous preform. The preforming method is carried out by means of the preforming tool as described above. The method comprises a step of inflating the first membrane 11. Air is blown into the chamber 12 of the first membrane via the inflation system.

The method then comprises a placing of the fibrous preform with a fibrous reinforcement on the first membrane 11 which is then inflated. For this purpose, various fibrous folds are arranged one by one on the outer wall of the first so as to form a thickness of the fibrous reinforcement. These folds are also humidified so as to allow the fibers to be held together until all the fibrous folds are arranged on the first membrane 11. We understand that the fibers of the fibrous reinforcement are non-impregnated. The fibrous reinforcement is not previously impregnated with a resin.

Advantageously, but not limited, water is used to humidified the various folds. The water is preferably filtered and deionized.

The second membrane 18 is then applied over the resulting wet or humidified fibrous preform and the first membrane. The fibrous preform is thus located between the first membrane and the second membrane, and in particular in the internal and fluid-tight cavity 19 of the tool.

An evacuation is made in the internal cavity 19. This is made by means of the above-mentioned evacuation device. The evacuation will compact the fibers together and dry the fibers of the fibrous folds forming the humidified fibrous preform. The water is evacuated by lowering its boiling point. All the folds are firmly joined together at the end of this step. The evacuation is carried out for a predetermined period of time, for example a few seconds. The evacuation is also carried out at a pressure of between 0.005 and 0.100 bar.

The preform is then demolded. For this purpose, the second membrane 18 is removed from the first membrane 11, as well as the preform itself, and then the first membrane 11 is deflated. We obtain a preformed, dry and compact preform.

Once the preformed preform has been demolded, this latter can be inspected visually and also by non-destructive testing (e.g. via a scan or a tomography device). In the event that a fold is misplaced, the preform can be humidified again to facilitate the displacement of the fold in question.

Once the shape of the preform is attached (preformed), the dry preform is placed in an injection mold by using, for example, the RTM (Resin Transfer Molding) technology. Its displacement is facilitated thanks to its preforming. There is no risk of the fibres slipping together.

A matrix is injected into the mold so as to carry out an impregnation and a densification of the fibres of the fibrous preform and thus obtain the composite material part, in this case the conduit. The mold comprises a first recess intended to receive the preformed preform here dry. A counter-mold having a second recess is intended to form a space of injection of the matrix with the first recess. The matrix is chosen according to the desired application. The matrix can be an epoxy-based thermosetting resin or a phenolic resin such as the polybismaleimides (BMI). Prior to the matrix injection, the injection mold is closed with the counter-mold. Other methods such as infusion, RTM light or Polyflex are, of course, possible.

1. A tool for preforming a fibrous preform, characterized in that it comprises
an inflatable first membrane intended to receive the fibrous preform,
a second membrane intended to attach to the first membrane via an attachment system and so as to form a fluid-tight internal cavity between the first and the second membranes, and
a device for evacuating the internal cavity between the first membrane and the second membrane.

2. The tool according to claim 1, wherein the first membrane comprises a wall which is closed so as to form a chamber.

3. The tool according to claim 1, wherein at least the first membrane is made of an elastic material.

4. The tool according to claim 3, wherein the elastic material comprises a silicone.

5. The tool according to claim 1, wherein the first membrane and the second membrane are releasably attached to each other.

6. The tool according to claim 1, wherein the fluid-tight attachment system comprises sealing elements.

7. The tool according to claim 1, wherein the evacuation device comprises a vacuum pump or a venturi effect system or a compressor.

8. A method for preforming a fibrous preform, wherein it comprises the following steps:
providing a preforming tool comprising an inflatable first membrane and a second membrane attached to the first membrane so as to form a fluid-tight internal cavity between the first and the second membranes;
inflating the first membrane;
placing fibrous folds intended to form a fibrous preform on the first membrane;
applying the second membrane on the fibrous preform and on the first membrane;
evacuating the internal cavity between the first and the second membranes; and
demolding the preformed and dry fibrous preform.

9. The preforming method according to claim 8, wherein the step of placing the folds comprises a humidification of each fibrous fold forming the humidified fibrous preform.

10. The preforming method according to claim 9, wherein the fibers of the fibrous preform are not impregnated with a resin before the humidification.

11. The preforming method according to claim 9, wherein the evacuation step comprises a drying and a compacting of the humidified fibrous preform.

12. The preforming method according to claim 8, wherein the humidification is carried out with deionized and filtered water.

13. The preforming method according to claim 8, wherein the step for demolding the preformed fibrous preform comprises a removing of the second membrane and a deflating of the first membrane.

14. A method for manufacturing a turbomachine part made of composite material, comprising the following steps:
producing a fibrous preform;
preforming the fibrous preform according to a method according to claim 8;
placing the dry preformed preform in an injection mold; and
injecting a matrix into the fibrous preform.
